(19) United States
(12) Patent Application Publication
(10) Pub. No.: US 2009/0231569 A1
(43) Pub. Date: Sep. 17, 2009

(54) EXPOSURE METHOD, EXPOSURE APPARATUS, AND METHOD OF MANUFACTURING DEVICE

(75) Inventor: Hironori Maeda, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/397,986

(22) Filed: Mar. 4, 2009

(30) Foreign Application Priority Data
Mar. 14, 2008 (JP) 2008-066733

(51) Int. Cl. G03B 27/42

(52) U.S. Cl. 355/77

(57) ABSTRACT

The first evaluation value is obtained by evaluating an electrical signal containing the position information of a mark in accordance with an evaluation criterion. The first overlay error generated by the exposure apparatus is estimated based on the first evaluation value, the second evaluation value obtained by evaluating an electrical signal in a position detector of the another exposure apparatus in accordance with the evaluation criterion, and the second overlay error generated by another exposure apparatus. The exposure apparatus exposes a substrate while positioning it so as to reduce an overlay error generated by the exposure apparatus to an error smaller than the first overlay error based on the basis of an output from the position detector of the exposure apparatus, which detects the position of the mark, and the estimated first overlay error.

### BACKGROUND OF THE INVENTION

1. Field of the Invention

The present invention relates to an exposure method, an exposure apparatus, and a method of manufacturing a device.

2. Description of the Related Art

In manufacturing a device such as a semiconductor device, a liquid crystal display device, or a thin-film magnetic head by using a photolithography technique, a projection exposure apparatus has been conventionally used, which transfers a pattern drawn on a reticle (photomask) onto a wafer or the like by projecting it on the wafer by using a projection optical system. In this transfer process, a projection image of a mask pattern formed via a projection optical system is aligned with a pattern, which has already been formed on a wafer, by using an alignment detection system mounted in a projection exposure apparatus. Thereafter, exposure is performed.

With decreases in the size and increases in the packing density of integrated circuits, a projection exposure apparatus is required to project and expose a reticle pattern onto a wafer with a higher resolution. The minimum line width (resolution) which can be transferred by a projection exposure apparatus is proportional to the wavelength of light used for exposure and inversely proportional to the numerical aperture (N. A.) of a projection optical system. Therefore, the shorter the wavelength, the higher the resolution. Recently, therefore, the light sources to be used have shifted from an ultra-high pressure mercury lamp which irradiates a g line (a wavelength of about 436 nm) and an i line (a wavelength of about 365 nm) to light sources which irradiate a KrF excimer laser (a wavelength of about 248 nm) and an ArF excimer laser (a wavelength of about 193 nm). In addition, an F₂ laser (a wavelength of about 157 nm) has been studied for practical use. A light source which irradiates extreme ultra violet light (EUV light) having a wavelength of several nm to hundred nm is expected to be used in the future.

Recently, an immersion exposure apparatus has also come on the market, which is designed to improve the resolution by increasing the N. A. by immersing at least part of the space between a projection optical system and a wafer in a liquid having a refractive index of 1 or more. In this immersion exposure apparatus, the space between a wafer and an optical element forming the distal end face of a projection optical system which is located on the wafer side is filled with a liquid having a refractive index close to the refractive index of a photoresist layer. Filling the space with a liquid in this manner can increase the effective numerical aperture of the projection optical system when viewed from the wafer side and improve the resolution.

With the advent of the method of shortening the wavelength of exposure light and the immersion method, the resolution has increasingly improved, and the correction accuracy (overlay accuracy) of a wafer overlay error amount is also required to be improved. In general, the overlay accuracy is required to be about ⅕ the accuracy required to express a resolution. With decreases in the size of semiconductor devices, it becomes increasingly important to improve the overlay accuracy.

Roughly two types of alignment detection systems have been disclosed and used. The first is an Off-axis Auto Alignment system (OA detection system) which has an alignment detection system separately disposed without via a projection optical system and optically detects an alignment mark on a wafer. The second is a system which detects an alignment mark on a wafer by using the alignment wavelength of non-exposure light via a projection optical system of the Through The Lens Auto Alignment (TTL-AA) scheme as an alignment scheme in an i-line exposure apparatus.

A water induced shift (WIS) sometimes occurs at the time of actual wafer alignment due to a manufacture process. This is a factor that degrades the performance of a semiconductor device and the yield of semiconductor device manufacture. An example of a WIS is that an alignment mark has an asymmetrical structure or a resist applied to a wafer has an asymmetrical shape due to the influences of planarization processes such as a CMP (Chemical Mechanical Polish) process.

Another error factor in wafer alignment is a TIS (Tool Induced Shift) in an alignment detection system. A TIS in the alignment detection system is, for example, residual aberration (comatic aberration due to decentration, in particular) in the alignment detection system itself or the tilt of the optical axis of an optical system (to be referred to as an optical axis shift hereinafter) in the detection system. A WIS and a TIS and the synergistic effect between them degrade the overlay accuracy of wafers.

In order to improve the wafer overlay accuracy, for example, the following method is generally used. In this method, a given real device wafer is actually exposed, and an exposure offset (a wafer magnification component, rotation component, or shift component) calculated from an overlay error amount based on the inspection result obtained by an overlay inspection apparatus is determined, and corrected. A technique of obtaining an exposure offset by using such an overlay inspection apparatus is disclosed in, for example, Japanese Patent Laid-Open No. 2004-119477. However, an exposure offset is also caused by the performance (TIS) of an alignment detection system. With regard to the same real device wafer, therefore, the exposure offset obtained by a given exposure apparatus cannot be applied as an exposure offset to another exposure apparatus. That is, according to the conventional technique, when alignment is to be performed by a plurality of exposure apparatuses using the same real device wafer, it is necessary for all the exposure apparatuses to expose the real device wafer and inspect the wafer by using overlay inspection apparatuses so as to obtain an exposure offset for each exposure apparatus.

In consideration of the total throughput in the manufacture of semiconductor devices, however, it is not desirable that all the exposure apparatuses which will be used to expose the same real device wafer respectively obtain exposure offsets, in spite of the fact that the same real device wafer is exposed. In addition, in order to allow all the exposure apparatuses to respectively obtain exposure offsets, a plurality of overlay inspection apparatuses are required, resulting in an increase in cost.

Assume that the exposure offset obtained by a given exposure apparatus is applied as an exposure offset for other exposure apparatuses to obtain a higher throughput. In this case, since the TISs in the alignment detection systems in the respective exposure apparatuses differ from each other, the alignment accuracy deteriorates. For this reason, the performance of semiconductor devices and the yield of semiconductor device manufacture decrease.

### SUMMARY OF THE INVENTION

It is, therefore, an object of the present invention to correct the overlay error amount of a substrate with high overlay accuracy and high throughput without any increase in cost.

According to the present invention, there is provided an exposure method of exposing a substrate by using an exposure apparatus which exposes the substrate while positioning the substrate based on an output from a position detector which detects a position of a mark by processing an electrical signal including position information of the mark, the method comprises steps of obtaining a first evaluation value by evaluating the electrical signal in accordance with an evaluation criterion, estimating a first overlay error generated by the exposure apparatus based on the first evaluation value, a second evaluation value obtained by evaluating an electrical signal in a position detector of another exposure apparatus in accordance with the evaluation criterion, and a second overlay error generated by the another exposure apparatus, and causing the exposure apparatus to expose the substrate while positioning the substrate so as to reduce an overlay error generated by the exposure apparatus to an error smaller than the first overlay error based on an output from the position detector of the exposure apparatus and the first overlay error estimated in the estimating step.

According to the present invention, it is possible to correct the overlay error amount of a substrate with high overlay accuracy and high throughput without any increase in cost.

Further features of the present invention will become apparent from the following description of exemplary embodiments with reference to the attached drawings.

### BRIEF DESCRIPTION OF THE DRAWINGS

FIG. 1 is a view schematically showing the arrangement of an exposure apparatus of the present invention;

FIG. 2 is a view showing a wafer and wafer alignment marks in the exposure apparatus in FIG. 1;

FIG. 3 is a view showing the details of the OA detection system of the exposure apparatus of the present invention;

FIG. 4 is a view for explaining how an exposure offset is conventionally corrected;

FIG. 5 is a view for explaining how an exposure offset is conventionally corrected;

FIG. 6A is a graph showing an alignment waveform in the exposure apparatus;

FIG. 6B is a graph showing an alignment waveform in the exposure apparatus;

FIG. 7 is a graph showing the relationship between evaluation values and true offsets;

FIG. 8 is a view for explaining how an exposure offset is corrected in the present invention;

FIG. 9A is a graph showing an alignment waveform in the exposure apparatus;

FIG. 9B is a graph showing an alignment waveform in the exposure apparatus;

FIG. 10 is a view showing a case in which there is a plurality of exposure apparatuses in a factory;

FIG. 11 is a view for explaining a method of calculating an evaluation value within a wafer plane; and

FIG. 12 is a view for explaining a method of calculating an evaluation value within a wafer plane.

### DESCRIPTION OF THE EMBODIMENTS

It is an object of the present invention to provide an exposure apparatus which can correct the overlay error amount of a substrate (wafer) with high overlay accuracy and high throughput. This invention is characterized in that once a given exposure apparatus obtains an exposure offset for a given real device wafer, all the exposure apparatuses which are going to perform alignment by using the real device wafer calculate exposure offsets without causing overlay inspection apparatuses to expose the real device wafer and inspect it.

In addition, the present invention can be applied to any types of exposure apparatuses as long as they are designed to expose the same real device wafer, and can also applied to an exposure apparatus of the type which includes a plurality of projection optical systems and alignment detection systems within the apparatus.

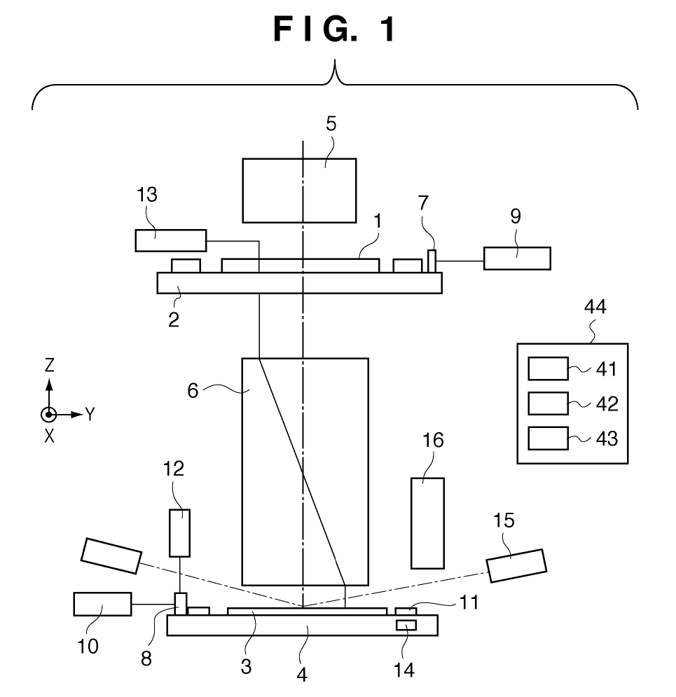

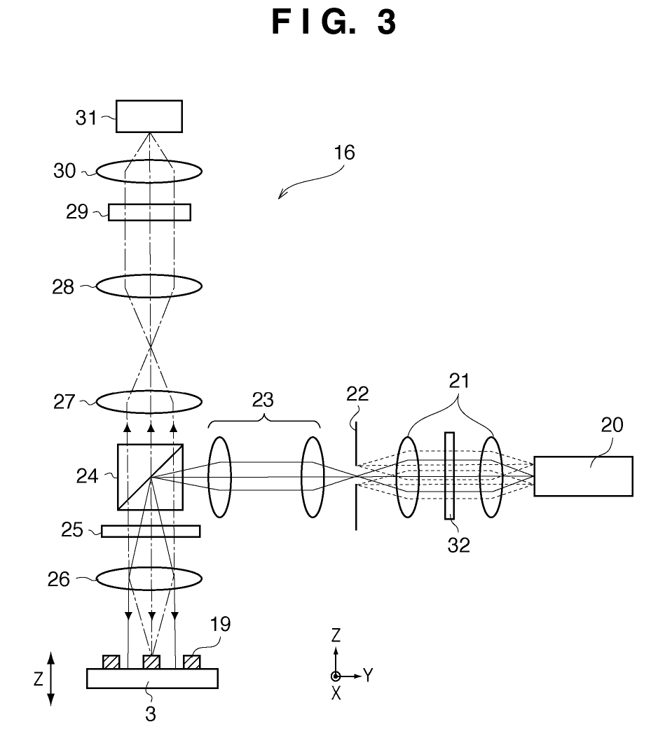

A case in which the present invention is applied to an alignment detection system mounted in a semiconductor exposure apparatus or liquid crystal exposure apparatus will be described below with reference to the accompanying drawings. The present invention will be described with the use of the exposure apparatus in FIG. 1 and the alignment detection system in FIG. 3.

Referring to FIG. 1, this exposure apparatus includes a reticle stage 2 which supports a reticle 1, a wafer stage 4 which supports a wafer 3, and an illumination optical system 5 which illuminates the reticle 1 supported on the reticle stage 2 with exposure light. The apparatus also includes a projection optical system 6 which projects and exposes a reticle pattern image of the reticle 1 illuminated with the exposure light onto the wafer 3 supported on the wafer stage 4, and a controller 44 which controls the overall operation of the exposure apparatus.

The following will exemplify a case in which a scanning exposure apparatus (scanning stepper) is used as an exposure apparatus, which exposes the reticle pattern formed on the reticle 1 onto the wafer 3 while synchronously moving the reticle 1 and the wafer 3 in the scanning direction. Note that the present invention can also be applied to an exposure apparatus (stepper) of the type designed to expose a reticle pattern on the wafer 3 while fixing the reticle 1 in position. In the following description, the optical axis direction of the projection optical system 6 is the Z-axis direction, the moving direction (scanning direction) of the reticle 1 and wafer 3 within a plane perpendicular to the Z-axis direction is the Y-axis direction, and a direction perpendicular to the Z-axis direction and the Y-axis direction is the X-axis direction. In addition, directions around the X-axis, the Y-axis, and Z-axis are the θX, θY, and θZ directions, respectively.

The illumination optical system 5 illuminates a predetermined illumination area on the reticle 1 with exposure light having a uniform illuminance distribution. As an exposure light source to be irradiated from the illumination optical system 5, a KrF excimer laser has been used in place of light from a mercury lamp which has been mainly used so far. Furthermore, an ArF excimer laser and F₂ laser have been studied for practical use. In addition, in order to manufacture smaller semiconductor devices and the like, an exposure apparatus using extreme ultra violet light (EUV light) having a wavelength of several nm to hundred nm as exposure light is under development.

The reticle stage 2 supports the reticle 1. The reticle stage 2 can two-dimensionally move within a plane perpendicular to the optical axis of the projection optical system 6, i.e., the X-Y plane, and can finely rotate in the θZ direction. The reticle stage 2 can use any of first to six axis drive systems. A driving apparatus (not shown) such as a linear motor drives the reticle stage 2. The controller 44 controls the driving apparatus of the reticle stage. A mirror 7 is provided on the reticle stage 2. An X/Y-direction laser interferometer 9 for measuring the position of the mirror 7 is provided at a position facing the mirror 7. The laser interferometer 9 measures the position and rotational angle of the reticle 1 on the reticle stage 2 in a two-dimensional direction in real time, and outputs the measurement result to the controller 44. The controller 44 positions the reticle 1 supported on the reticle stage 2 by driving the driving apparatus of the reticle stage on the basis of the measurement result obtained by the laser interferometer 9.

The projection optical system 6 projects and exposes a reticle pattern of the reticle 1 on the wafer 3 at a predetermined projection magnification β. The projection optical system 6 includes a plurality of optical elements. In this embodiment, the projection optical system 6 is a reduction projection system with the projection magnification β being set to ¼ or ⅕.

The wafer stage 4 supports the wafer 3, and includes a Z stage which holds the wafer 3 through a wafer chuck, an X-Y stage which supports the Z stage, and a base which supports the X-Y stage. A driving apparatus (not shown) such as a linear motor drives the wafer stage 4. The controller 44 controls the driving apparatus of the wafer stage.

A mirror 8 which moves together with the wafer stage 4 is provided on the wafer stage 4. An X/Y-direction laser interferometer 10 for measuring the mirror 8 and a Z-direction laser interferometer 12 for measuring the mirror 8 on the wafer stage are provided at positions facing the mirror 8. The laser interferometer 10 measures the positions of the wafer stage 4 in the X and Y directions and θZ in real time, and outputs the measurement result to the controller 44. The laser interferometer 12 measures the position of the wafer stage 4 in the Z direction and θ X and θY in real time, and outputs the measurement result to the controller 44. The driving apparatus of the wafer stage drives the X-Y and Z stages to adjust the positions of the wafer 3 in the X, Y, and Z directions on the basis of the measurement results obtained by the laser interferometers 10 and 12, thereby positioning the wafer 3 supported on the wafer stage 4.

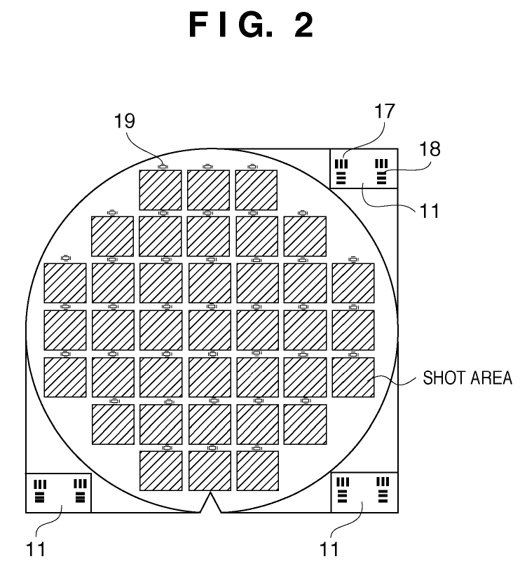

A reticle alignment detection system 13 is provided near the reticle stage 2. The reticle alignment detection system 13 detects reticle reference marks (not shown) on the reticle 1 placed on the reticle stage and reference marks 17 (see FIG. 2) for the reticle alignment detection system which are formed on stage reference plates 11 on the wafer stage 4. Note that the reference marks 17 for the reticle alignment detection system are detected via the projection optical system 6. The same light source as that actually exposes the wafer 3 irradiates the reticle reference marks and the reference marks 17 for the reticle alignment detection system. The reticle alignment detection system 13 is equipped with a photoelectric conversion device such as a CCD camera, and detects the light reflected by the reticle reference marks and the reference marks 17 for the reticle alignment detection system.

The reticle and the wafer are positioned on the basis of signals from this photoelectric conversion device. At this time, positioning the reticle reference marks and the reference marks 17 for the reticle alignment detection system and bringing them into focus can match the reticle and the wafer in terms of the relative positional relationship (X, Y, Z).

In addition, the reference marks for the reticle alignment detection system which are detected by the reticle alignment detection system 13 can be reflection type marks. In contrast, using these marks as reference marks for a transmission type reticle alignment detection system can detect transmitted light from the reference marks for the reticle alignment detection system by using a transmission type reticle alignment detection system 14.

The transmission type reticle alignment detection system 14 is equipped with a light amount sensor and the like. The light amount sensor and the like detect transmitted light emitted by a light source, which actually exposes the wafer 3 via the illumination optical system 5 and the projection optical system 6, and is irradiated on each reticle reference mark and the reference mark 17 for the reticle alignment detection system. At this time, measuring the amount of transmitted light while driving the wafer stage 4 in the X direction, the Y direction, or the Z direction makes it possible to position each reticle reference mark and the reference mark 17 for the reticle alignment detection system and bring them into focus.

Using either the reticle alignment detection system 13 or the transmission type reticle alignment detection system 14 in this manner can match the reticle and the wafer in terms of the relative positional relationship (X, Y, Z).

The stage reference plates 11 at corners of the wafer stage 4 are set at almost the same level as the surface of the wafer 3. Each stage reference plate 11 includes a reference mark 18 (see FIG. 2) for an OA detection system, whose position is detected by an OA detection system 16 as a position detector. Each stage reference plates 11 also includes the reference mark 17 for the reticle alignment detection system, which is detected by the reticle alignment detection system 13 or the transmission type reticle alignment detection system 14. The stage reference plate 11 may be placed on one corner of the wafer stage 4 or stage reference plates 11 may be placed at a plurality of corners of the wafer stage 4. One stage reference plate 11 may include a plurality of reference marks 17 for the reticle alignment detection system and a plurality of reference marks 18 for the OA detection system instead of one each of them. Assume that the positional relationship (X and Y directions) between the reference marks 17 for the reticle alignment detection system and the reference marks 18 for the OA detection system is known. Note that the reference mark 18 for the OA detection system may be identical to the reference mark 17 for the reticle alignment detection system.

A focus detection system 15 includes an irradiation system which irradiates the surface of the wafer 3 with detection light for detecting a focus condition and a light receiving system which receives reflected light from the wafer 3. The focus detection system 15 outputs a detection result to the controller 44. The controller 44 can adjust the position (focus position) and tilt angle of the wafer 3, held on the Z stage, in the Z-axis direction by driving the Z stage on the basis of the detection result obtained by the focus detection system 15.

The OA detection system 16 incorporates an irradiation system which irradiates wafer alignment marks 19 (see FIG. 2) on the wafer 3, which is an object to be detected, and the reference marks 18 for the OA detection system on the stage reference plates 11 with detection light for OA detection. The OA detection system 16 also incorporates a light receiving system which receives reflected light from these marks. The OA detection system 16 outputs a detection result to the controller 44. The controller 44 can adjust the positions of the wafer 3, held on the wafer stage 4, in the X and Y directions by driving the wafer stage 4 in the X and Y directions on the basis of the detection result obtained by the OA detection system 16.

FIG. 3 shows the details of the OA detection system 16. Referring to FIG. 3, light guided from an illumination light source 20 (a fiber or the like) for the OA detection system passes through a relay optical system 21 and a wavelength filter plate 32 and reaches an aperture stop 22 at a position corresponding to the pupil plane of the OA detection system 16 (an optical Fourier transform plane corresponding to an object surface). At this time, the beam diameter reduced by the aperture stop 22 becomes sufficiently smaller than that at the illumination light source 20 for the OA detection system. A plurality of types of filters having different transmission wavelength bands are inserted in the wavelength filter plate 32. The filters are switched in accordance with an instruction from the controller 44. A plurality of types of stops having different illuminations σ are prepared for the aperture stop 22. Switching the stops in accordance with an instruction from the controller 44 can switch the illuminations σ.

Light which has been emitted by the illumination light source 20 for the OA detection system and has reached the aperture stop 22 is guided to a polarizing beam splitter 24 via an illumination optical system 23 for the OA detection system. S-polarized light perpendicular to the drawing surface, which is reflected by the polarizing beam splitter 24, is transmitted through a λ/4 plate 25 to be converted into circularly polarized light. This light passes through an objective lens 26 and Koehler-illuminates the wafer alignment mark 19 formed on the wafer 3 (the illumination light is indicated by the solid lines in FIG. 3).

Reflected light, diffracted light, and scattered light (indicated by the chain lines in FIG. 3) from the wafer alignment mark 19 pass through the objective lens 26 and the λ/4 plate 25 again, are converted into P-polarized light parallel to the drawing surface this time, and are transmitted through the polarizing beam splitter 24. A relay lens 27, a first imaging optical system 28, an optical member 29 for comatic aberration adjustment, and a second imaging optical system 30 form an image of the wafer alignment mark 19 on a photoelectric conversion device 31 (e.g., a CCD camera). The position of the wafer 3 is then detected on the basis of the position of each photoelectrically converted alignment mark image.

In general, when the OA detection system 16 described above detects the position of the wafer alignment mark 19 by observing it on the wafer 3, monochrome light generates interference fringes because of the transparent layer formed on the wafer alignment mark 19 by coating. For this reason, an alignment signal is detected while an interference fringe signal is added to the alignment signal. This makes it impossible to perform accurate detection. Therefore, in general, as the illumination light source 20 of the OA detection system 16, a light source having a wide wavelength band is used, and a signal with few interference fringes is detected.

In order to detect the wafer alignment mark 19 on the wafer 3 with high accuracy, it is necessary to clearly detect an image of the wafer alignment mark 19. That is, the OA detection system 16 must be brought into focus on the wafer alignment mark 19. For this purpose, an AF detection system (not shown) is generally formed in the OA detection system, and the wafer alignment mark 19 is detected by driving the wafer alignment mark 19 to the best focus plane of the OA detection system 16 on the basis of the detection result of the AF detection system. The evaluation value to be described later is obtained on the basis of a detection signal based on the wafer alignment mark 19 detected in this manner.

The manner of obtaining an exposure offset in the conventional exposure apparatus will be described next. After wafer alignment is performed under given conditions (e.g., a wavelength and illumination σ) of the OA detection system, and a given real device wafer is positioned, exposure on the real device wafer is performed. The overlay inspection apparatus inspects the exposed real device wafer to calculate an exposure offset. The overlay accuracy of the exposure apparatus (the correction accuracy of wafer overlay error amount) is improved by correcting the calculated exposure offset. This method corrects the true offset value which the exposure apparatus and the OA detection system have by actually exposing a real device wafer.

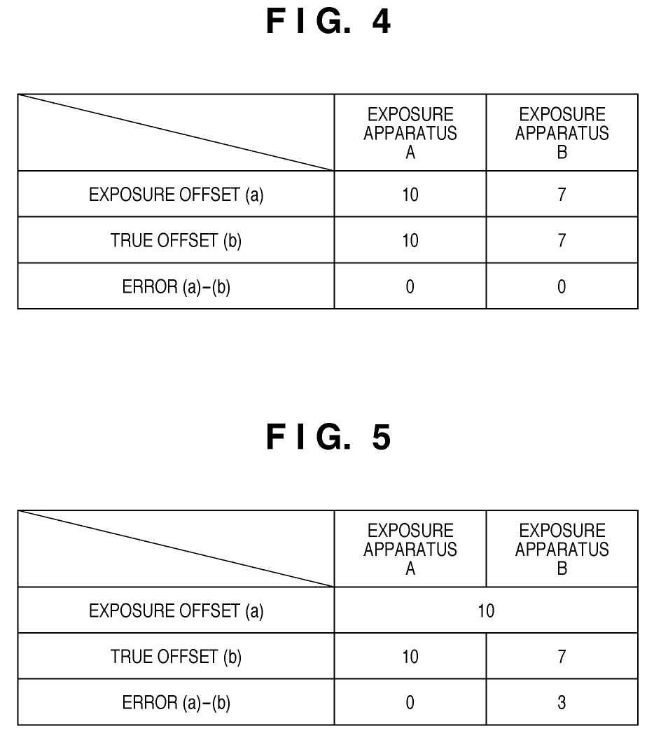

The conventional manner of obtaining an exposure offset when a plurality of exposure apparatuses are to expose the same real device wafer will be described. FIG. 4 shows the manner of obtaining an exposure offset for the same real device in exposure apparatuses A and B. First of all, the exposure apparatuses A and B separately expose the same real device wafer, and obtain exposure offsets on the basis of the inspection results obtained by the overlay inspection apparatuses. At this time, conditions for the OA detection systems at the time of alignment of the wafer by the exposure apparatuses A and B may be the same or different. The calculated exposure offsets receive the influences of TISs of the OA detection systems and the synergistic effect between WISs and TISs as well as the influences of WISs of the real device wafer, and hence may become different values in the exposure apparatuses A and B. Correcting the exposure offsets in the exposure apparatuses A and B, which have been calculated so far, can implement high-accuracy overlay without error in each of the exposure apparatuses A and B (with no error between an exposure offset and a true offset).

Although the above description using FIG. 4 has exemplified the two exposure apparatuses, the number of exposure apparatuses is not limited to two. In order to implement high-accuracy overlay even with three exposure apparatuses, it is necessary to obtain exposure offsets in the respective exposure apparatuses. According to this technique, however, it is necessary for all the exposure apparatuses to expose wafers and inspect all the wafers by using the overlay inspection apparatuses. The technique is therefore undesirable in terms of throughput. Preparing a plurality of overlay inspection apparatuses to increase the throughput as much as possible is undesirable in terms of cost.

If the exposure offset obtained by a given exposure apparatus is commonly used for other exposure apparatuses which expose the same real device wafer in consideration of above the throughput and cost, the throughput can be reliably increased. However, an alignment error occurs, and the overlay accuracy deteriorates. FIG. 5 shows an overlay accuracy in a case in which the exposure offset calculated by the exposure apparatus A is commonly used in the exposure apparatus B. The exposure apparatus A actually exposes the wafer. The apparatus then calculates and corrects an exposure offset by using the overlay inspection apparatus, and hence can implement high-accuracy overlay without error. On the other hand, the TIS of the OA detection system in the exposure apparatus B differs from that in the exposure apparatus A, and hence the true offset amounts (b) in the exposure apparatuses A and B take different values. If, therefore, the exposure offset calculated by the exposure apparatus B is used in the exposure apparatus A, an error relative to the true offset amount occurs, and the overlay accuracy deteriorates.

The present invention is made to solve the above problem. More specifically, this invention is characterized in that an exposure offset (first overlay error) in a given exposure apparatus is estimated on the basis of the exposure offset (second overlay error) obtained by exposure on a wafer by another exposure apparatus and the first and second evaluation values in the first and second exposure apparatuses. An overlay error correction method using the present invention will be described below.

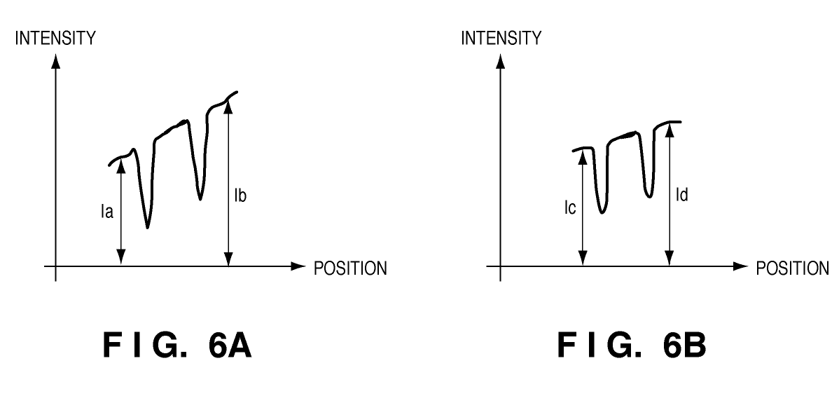

The waveform in FIG. 6A is the waveform obtained when an exposure apparatus C detects a wafer alignment mark on a given substrate (real device wafer). The waveform in FIG. 6B is the waveform obtained when an exposure apparatus D detects the same mark. The abscissas of FIGS. 6A and 6B indicate the positions of alignment marks based on position information which the waveforms (electrical signals) contain; and the ordinates, the intensities of electrical signals (signal intensities) at the time of detection of the alignment marks. The reason why the waveforms in FIGS. 6A and 6B differ from each other in spite of the fact that the same wafer alignment mark on the same real device wafer is measured is that the TIS of the OA detection system of the exposure apparatus C differs from that of the exposure apparatus D. Signal intensities at the same positions (portions) of the waveforms in FIGS. 6A and 6B are respectively represented by Ia and Ic, and Ib and Id. It is empirically known that when the gradients of the waveforms are set as evaluation criteria, and Ib/Ia and Id/Ic obtained in accordance with the evaluation criteria are introduced into an evaluation unit 41, the evaluation values have correlations with the true offsets which the exposure apparatuses have.

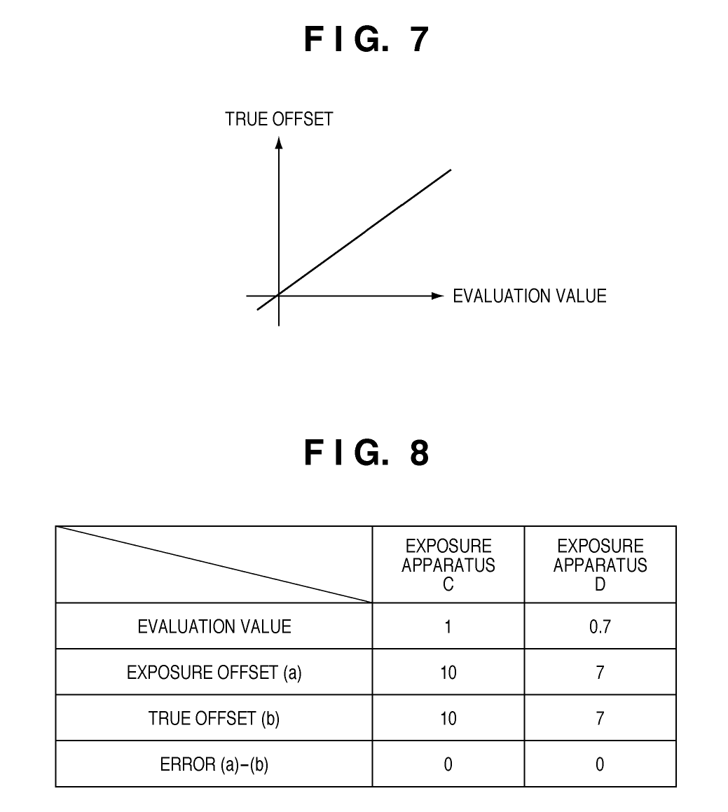

FIG. 7 is a graph showing the relationship between evaluation values and true offsets in the same real device wafer. This graph indicates that the larger the evaluation value representing the gradient of the waveform, the larger the true offset, and vice versa. That is, an evaluation value and a true offset have a correlation; they have a proportionality relation. The present invention is characterized in that an estimation unit 42 estimates (calculates) a true offset in the exposure apparatus by using the correlation between evaluation values and true offsets without obtaining an exposure offset by actually exposing a real device wafer. The present invention is further characterized in that a control unit 43 performs control on the basis of an estimated exposure offset (overlay error) to expose a substrate while positioning it so as to reduce the overlay error generated by the exposure apparatus to an error smaller than the estimated overlay error.

FIG. 8 shows a case in which an exposure apparatus has calculated exposure offsets by using the present invention without actually exposing a real device wafer. Referring to FIG. 8, exposure apparatuses C and D are exposure apparatuses which expose the same real device wafer, and the exposure apparatus C has calculated an exposure offset by actually exposing the real device wafer. Since the exposure apparatus C has calculated an exposure offset by actually exposing the real device wafer, the true offset in the exposure apparatus C can be corrected, and high-accuracy overlay can be implemented. In contrast, the exposure apparatus D obtains an exposure offset in consideration of the ratio between the evaluation values of alignment waveforms at the time of alignment of the real device wafer by the exposure apparatuses C and D instead of using the exposure offsets calculated by the exposure apparatus C without change.

Assume that as shown in FIG. 8, the evaluation value of the alignment waveform obtained by the exposure apparatus C which has measured the real device wafer is 1, and the evaluation value of the alignment waveform obtained by the exposure apparatus D which has measured the real device wafer is 0.7. If the exposure offset calculated by the exposure apparatus C is 10, the exposure offset in the exposure apparatus D is calculated as 10×(0.7/1)=7 according to the exposure offset calculated by the exposure apparatus C and the ratio between the evaluation values obtained by the exposure apparatuses C and D. Since there is a linear correlation between evaluation values and true offsets as shown in FIG. 7, using the exposure offset calculated by the exposure apparatus D by the above calculation can correct the true offset in the exposure apparatus D. As a result, the exposure apparatus D can implement high-accuracy overlay without exposing the real device wafer in the exposure apparatus D.

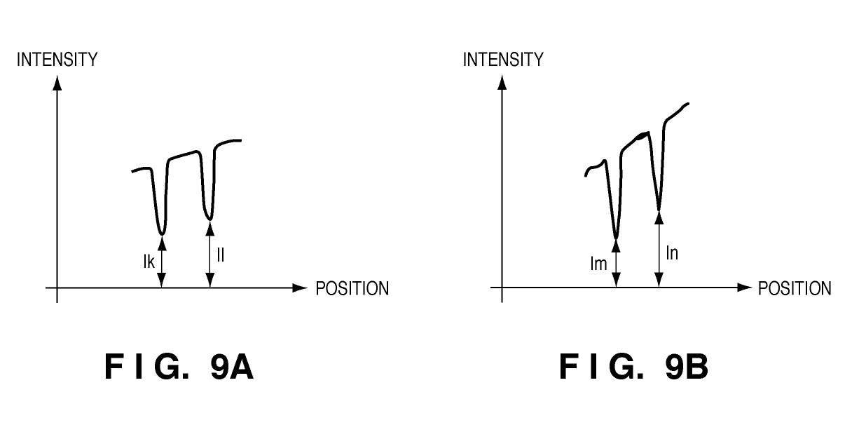

In the above embodiment, as evaluation values, Ib/Ia and Id/Ic representing the degrees of the tilts of the waveforms shown in FIGS. 6A and 6B are used. However, the present invention can use values other than the gradients of waveforms as evaluation values. The waveforms in FIGS. 9A and 9B are waveforms obtained when the exposure apparatuses C and D have detected a wafer alignment mark on the same real device wafer. Reference symbols Ik, Il, Im, and In respectively denote peak values of the waveforms in FIGS. 9A and 9B. It is also known that Il/Ik and In/Im of the waveforms in FIGS. 9A and 9B used as evaluation values have correlations with true offsets as shown in FIG. 7. Therefore, Il/Ik and In/Im as the ratios between the peak values of the waveforms can be used as evaluation values in place of Ib/Ia and Id/Ic representing the gradients of the waveforms. As described above, it suffices to use any evaluation values as long as they have correlations with true offsets like those shown in FIG. 7. Alternatively, it suffices to use evaluation values calculated by multiplying a plurality of evaluation values so as to make them have a better correlation with a true offset instead of using only one evaluation value.

In addition, as an evaluation value having a correlation with a true offset, an evaluation value distribution within a wafer plane of a real device wafer can be used. More specifically, first of all, the exposure apparatus measures wafer alignment marks in a plurality of places on a real device wafer (this operation will be referred to as global alignment) and obtains an evaluation value distribution within a wafer plane. The obtained evaluation value distribution within the wafer plane is statistically processed to obtain an evaluation value within the wafer plane (an evaluation value within the substrate plane) which has a correlation with a true offset. The evaluation value within the wafer plane is calculated as a rotation component, magnification component, or shift component of the wafer depending on the state of the real device wafer.

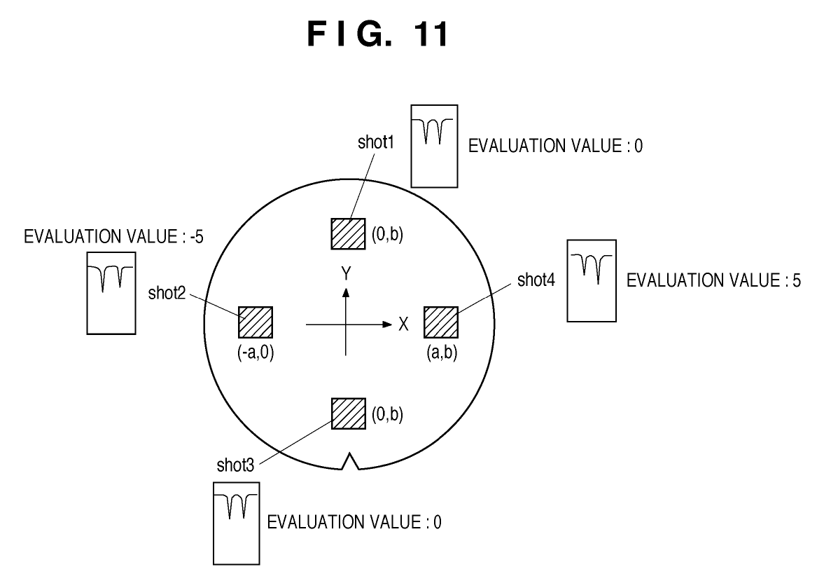

An evaluation value within a wafer plane which has a correlation with a true offset and is obtained from the above global alignment will be described below. FIG. 11 shows four shots 1, 2, 3, and 4 used for global alignment of a given device wafer and X waveforms detected from the respective shots. An evaluation value within a wafer plane is calculated from an evaluation value in each shot. The following description will exemplify the ratio between peak values of a waveform as the evaluation value of the waveform in each shot. The waveforms in shots 1 and 3 are symmetrical, and hence the evaluation values are 0. The evaluation value in shot 2 is −5. The evaluation value in shot 4 is +5. The coordinates of each shot in FIG. 11 are expressed by using a coordinate system within the wafer plane with the center of the wafer being the origin. The coordinates of shots 1, 2, 3, and 4 are respectively expressed by (0, b), (−a, 0), (0, −b), and (a, 0). In this case, the waveforms in shots 1 and 3 whose X-coordinates are 0 are symmetrical waveforms with an evaluation value of 0. The evaluation value in shot 4 whose X-coordinate is positive is +5. The evaluation value in shot 2 whose X-coordinate is negative is −5. It is therefore obvious that each evaluation value depends on the X-coordinate. In this case, the value obtained by dividing the difference between the evaluation value in shot 4 and the evaluation value in shot 2 by the difference between the X-coordinates with attention being given to the X direction, i.e., (5−(−5))/(a−(−a))=5/a, is obtained as the X-direction magnification component of the evaluation value within the wafer plane. It is known that the magnification component of an evaluation value within a wafer plane has a correlation with a true offset, and is used to calculate an exposure offset.

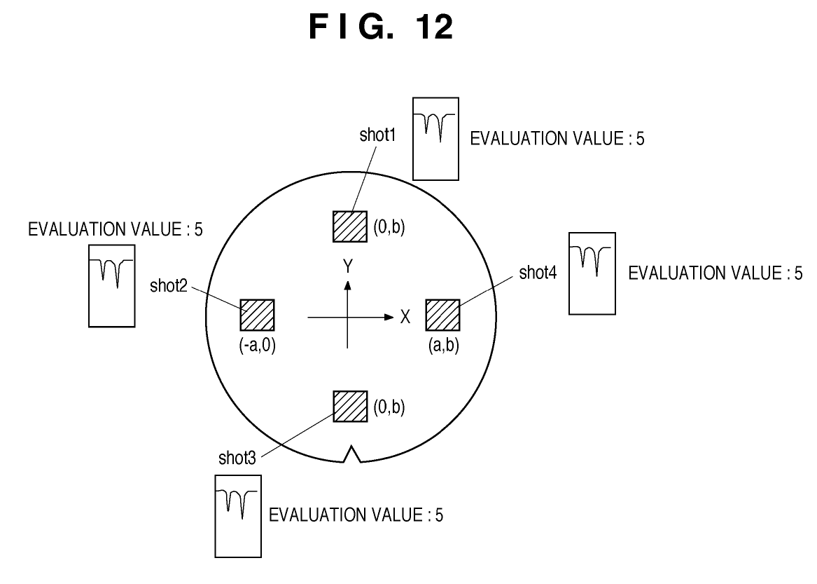

The description made above with reference to FIG. 11 is about the magnification component of an evaluation value within a wafer plane. The shift component of an evaluation value within a wafer plane will be described next with reference to FIG. 12. FIG. 12 shows X waveforms detected when global alignment is performed for four shots on a given real device wafer and evaluation values calculated from the X waveforms. In the following description, the ratio between peak values of the waveform is used as the evaluation value of the waveform in each shot. The waveforms shown in FIG. 12 in all the four shots have the same evaluation value. In this case, the real device wafer has an evaluation value of 5 in the X direction regardless of the X- and Y-coordinates, and is expressed as the X-direction shift component of an evaluation value within a wafer plane. It is known that the shift component of an evaluation value within a wafer plane has a correlation with a true offset, and is used to calculate an exposure offset.

The above descriptions made with reference to FIGS. 11 and 12 are based on the assumption that the number of measurement points for wafer alignment marks in global alignment is four for the sake of simplicity. Obviously, however, the number of measurement points can be four or more. Increasing the number of measurement points for wafer alignment marks makes it possible to calculate an evaluation value within a wafer plane which has a high degree of correlation with a true offset.

The above description is about the method of calculating exposure offsets from evaluation values of one real device wafer of a given lot by using the relational expression in FIG. 7. However, the present invention does not limit the number of real device wafers from which evaluation values are to be obtained to one. When, for example, some variations in real device wafers are expected among lots, it suffices to obtain evaluation values of a plurality of real device wafers and calculate an exposure offset from the average value of the evaluation values of the respective wafers.

Although a component originating from the performance of the OA detection system dominates an exposure offset, the offset contains a component due to the aberration of a projection optical system albeit in a small amount. An exposure offset can be calculated with higher accuracy by measuring the aberration of a projection optical system in advance using an aberration measurement unit, correcting the aberration, and then using the present invention. This can improve the performance of a semiconductor device and the yield of semiconductor device manufacture. More specifically, for example, before an exposure offset is obtained by exposing a real device wafer by using a given exposure apparatus (inevitably before the calculation of an exposure offset in another exposure apparatus), the aberration of the projection optical system of each exposure apparatus is measured and corrected in advance. The aberration of each projection optical system can be measured by using an aberration detection system (not shown) arranged in the exposure apparatus or can be obtained by actually exposing a pattern, developing it, and measuring an aberration amount from a pattern shift or a shape using a scanning electron microscope (SEM) or the like.

Using the present invention makes it possible to calculate exposure offsets for all exposure apparatuses designed to align a given real device wafer without exposing the real device wafer once an exposure offset for the real device wafer is obtained by a given exposure apparatus. This can implement high-accuracy alignment and achieve high throughputs in all exposure apparatuses designed to expose the real device wafer.

The present invention can provide an exposure apparatus including a unit for outputting a warning when an evaluation value exceeds a threshold and performing error termination of a subsequent exposure process. In addition, an exposure apparatus in which the evaluation value exceeds a given value may be configured to calculate an exposure offset by separately exposing a real device wafer.

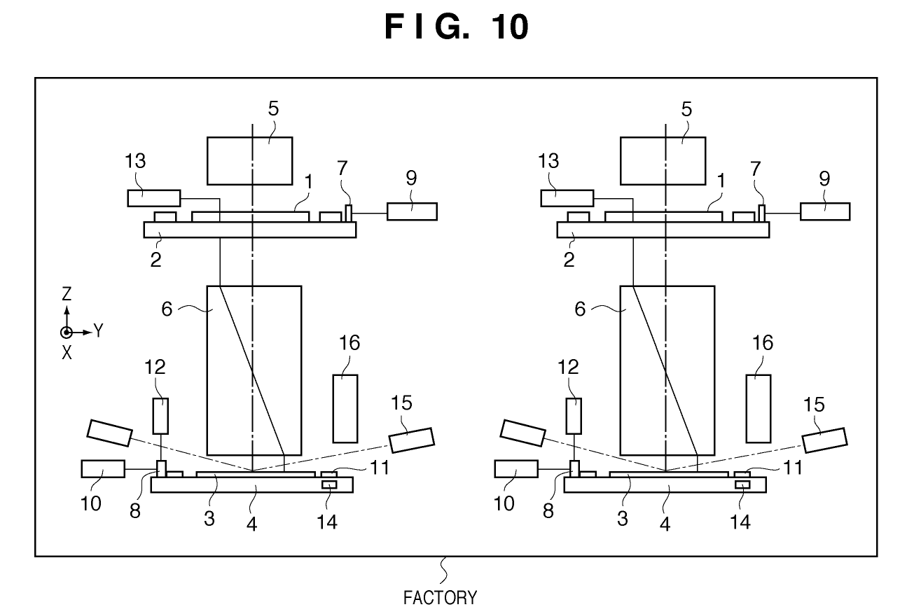

The present invention can also be applied to a case in which there are a plurality of exposure apparatuses in a factory, and the exposure offset of a real device wafer which is obtained by a given one of the exposure apparatuses is used to calculate exposure offsets in other exposure apparatuses. FIG. 10 shows a case in which there is a plurality of exposure apparatuses in such a factory. Although FIG. 10 shows a case in which there are two exposure apparatuses in a factory, three or more exposure apparatuses may be installed in a factory.

Although the above description has exemplified the case in which an alignment detection system is an OA detection system, the present invention can also be applied to a case in which an alignment detection system is an alignment detection system of the TTL-AA scheme.

Note that devices, e.g., semiconductor integrated circuit devices and liquid crystal display devices, can be manufactured by using the above exposure apparatus. Such a device is manufactured by a step of exposing a substrate (wafer) coated with a photosensitive agent using the above exposure apparatus, a step of developing the photosensitive agent, and other known steps (e.g., etching, resist removing, dicing, bonding, and packaging steps).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-066733, filed Mar. 14, 2008, which is hereby incorporated by reference herein in its entirety.

What is claimed is:

1. An exposure method of exposing a substrate by using an exposure apparatus which exposes the substrate while positioning the substrate based on an output from a position detector which detects a position of a mark by processing an electrical signal including position information of the mark, the method comprising steps of:
obtaining a first evaluation value by evaluating the electrical signal in accordance with an evaluation criterion;
estimating a first overlay error generated by the exposure apparatus based on the first evaluation value, a second evaluation value obtained by evaluating an electrical signal in a position detector of another exposure apparatus in accordance with the evaluation criterion, and a second overlay error generated by the another exposure apparatus; and
causing the exposure apparatus to expose the substrate while positioning the substrate so as to reduce an overlay error generated by the exposure apparatus to an error smaller than the first overlay error based on an output from the position detector of the exposure apparatus and the first overlay error estimated in the estimating step.

2. The method according to claim 1, wherein the first evaluation value and the second evaluation value are measured based on waveforms of electrical signals including pieces of position information of an alignment mark on a substrate which are respectively detected by the exposure apparatus and the other exposure apparatus, and are proportional to an overlay error.

3. The method according to claim 2, wherein the first evaluation value and the second evaluation value each are a ratio between signal intensities of the waveform at two predetermined portions of the alignment mark.

4. The method according to claim 1, further comprising a step of outputting a warning when at least one of the first evaluation value and the second evaluation value exceeds a threshold.

5. The method according to claim 4, further comprising a step of stopping execution of the exposing step after the warning step.

6. The method according to claim 2, wherein the first evaluation value and the second evaluation value each are an evaluation value within a substrate plane which is obtained based on evaluation values of a plurality of alignment marks arranged in a plurality of places on one substrate.

7. The method according to claim 1, wherein the first evaluation value and the second evaluation value each are an average value of evaluation values obtained from a plurality of substrates.

8. An exposure apparatus for exposing a substrate while positioning the substrate based on an output from a position detector which detects a position of a mark by processing an electrical signal including position information of the mark, the apparatus comprising:
an evaluation unit which obtains a first evaluation value by evaluating the electrical signal in accordance with an evaluation criterion;
an estimation unit which estimates a first overlay error generated by the exposure apparatus based on the first evaluation value, a second evaluation value obtained by evaluating an electrical signal in a position detector of another exposure apparatus in accordance with the evaluation criterion, and a second overlay error generated by the another exposure apparatus; and
a control unit which controls exposure on the substrate while positioning the substrate so as to reduce an overlay error generated by the exposure apparatus to an error smaller than the first overlay error based on an output from the position detector of the exposure apparatus and the first overlay error estimated by the estimation unit.

9. A method of manufacturing a device, the method comprising steps of:
exposing a substrate by using an exposure apparatus which exposes the substrate while positioning the substrate based on an output from a position detector which detects a position of a mark by processing an electrical signal including position information of the mark;
developing the exposed substrate; and
processing the developed substrate to manufacture the device,
the exposure apparatus including
an evaluation unit which obtains a first evaluation value by evaluating the electrical signal in accordance with an evaluation criterion,
an estimation unit which estimates a first overlay error generated by the exposure apparatus based on the first evaluation value, a second evaluation value obtained by evaluating an electrical signal in a position detector of another exposure apparatus in accordance with the evaluation criterion, and a second overlay error generated by the another exposure apparatus, and
a control unit which controls exposure on the substrate while positioning the substrate so as to reduce an overlay error generated by the exposure apparatus to an error smaller than the first overlay error based on an output from the position detector of the exposure apparatus and the first overlay error estimated by the estimation unit.
